(19) United States
(12) Patent Application Publication
(10) Pub. No.: US 2026/0175885 A1
(43) Pub. Date: Jun. 25, 2026

(54) METHOD FOR ASSESSING AN OPERATING STATE OF A MACHINE FOR MAINTAINING A RAILWAY LINE

(71) Applicant: TRACK MACHINES CONNECTED GESELLSCHAFT M.B.H., Linz (AT)

(72) Inventors: Benjamin STUNTNER, Ansfelden (AT); Jochen NOWOTNY, Gaaden bei Mödling (AT)

(73) Assignee: TRACK MACHINES CONNECTED GESELLSCHAFT M.B.H., Linz (AT)

(21) Appl. No.: 19/127,507

(22) PCT Filed: Nov. 6, 2023
(86) PCT No.: PCT/EP2023/080838

§ 371 Date: May 6, 2025

(30) Foreign Application Priority Data
Nov. 7, 2022 (AT) A 50845/2022

(51) Int. Cl. B61L 15/00

(52) U.S. Cl. CPC B61L 15/0081

(57) ABSTRACT

A method for detecting a safe operational state of a machine for maintaining a track at an execution time t2, which machine includes a computing unit including a timer, at least one electronic component, a component control unit and an internal database.

### CROSS-REFERENCE TO RELATED APPLICATIONS

The present application is a national phase application of PCT Application No. PCT/EP2023/080838, filed Nov. 6, 2023, entitled “METHOD FOR ASSESSING AN OPERATING STATE OF A MACHINE FOR MAINTAINING A RAILWAY LINE”, which claims the benefit of Austrian Patent Application No. A 50845/2022, filed Nov. 7, 2022, each of which is incorporated by reference in its entirety.

### BACKGROUND OF THE INVENTION

### 1. Field of the Invention

The invention relates to a method of detecting a safe operation of a machine at an execution time t2. The machine serves to maintain the railway line. The railway line includes, for example, the superstructure of a track, the track and the infrastructural facilities associated with the railway line.

The machine includes a computing unit, at least one electronic component, a component control unit and an internal database.

### 2. Description of the Related Art

An electronic component may be, for example, a sensor for recording a measurement value. The sensor control unit as a component control unit controls the sensor to record the at least one measurement value. Most simply, the sensor control unit activates the sensor to determine the measurement value.

An electronic component (shortly referred to in the following as component) may also be a network unit such as a router, a switch or generally an electronic component to establish a data connection. The component control unit controls the network unit.

In the internal database, one or multiple certificates of the machine are saved including a certificate time indication. The certificates may relate to the machine as a whole or an individual component of the machine such as the sensor, for example. A certificate comprises a certificate time indication. The certificate time indication defines until what time or in what period of time the machine or a component of the machine such as the sensor may be used. Outside of the defined time period or after the defined time period, the machine may not be used. The internal database may be formed as a singular internal database or as multiple internal databases physically or logically arranged near the individual components of the machine. The computing unit may retrieve one or multiple certificates from the one or multiple internal databases.

The external database and the internal database may have time-specific and/or user-specific restrictions of reading rights and writing rights.

Data connections exist between the units of the machine mentioned, such as, for example, computing unit, sensor, sensor control unit and the at least one internal database and the external database. The data connections may be subject to user-specific and/or time-specific access restrictions.

The machine may be, as an alternative to: in a delivery state at a delivery time t1, in a safe operational state or an unsafe operational state at an execution time t2. The delivery time t1 is prior in time to the execution time t2.

According to the current practice, operational states are evaluated by a person and recorded in an inspection report. In doing so, the person may adhere to standards or instructions.

The inspection reports prepared according to the current practice can be manipulated.

EP3907119A1 discloses a method of preparing a safety-relevant inspection report. In the EPO notification of 23 Jan. 2023, EP3907119A1 is critized as unclear. Due to this unclearness, EP3907119A1 is not to be regarded as fully described, making EP3907119A1 not part of the relevant prior art.

### SUMMARY OF THE INVENTION

The inventive method achieves the object of issuing a manipulation-proof record file to replace the inspection reports known according to the current teaching. Evaluation of the prevailing operational state is to be assisted by an automated technical process and free of any subjective human assessment.

In a first embodiment, the inventive method is characterized by the following method steps:
at the delivery time t1, the computing unit determines a first component identification of a first component,
the computing unit issues a first component identification signature based on the first component identification according to a digital signature scheme,
the computing unit saves the first component identification signature in the internal database and in the external database,
at the execution time t2, the computing unit requests a second component identification of a second component,
in response to said request, the second component sends a dataset to the component control unit, which dataset comprises the second component identification,
the computing unit saves the second component identification in the internal database,
the computing unit issues a second component identification signature based on the second component identification according to the digital signature scheme,
the computing unit compares the first component identification signature to the second component identification signature,
the computing unit detects a safe operational state, if the first component identification signature and the second component identification signature match,
the computing unit detects an unsafe operational state, if the first component identification signature and the second component identification signature do not match.

The first embodiment of the inventive method focuses on the evaluation of an operational state depending on the first sensor installed in the machine at the delivery time t1 and the second sensor installed in the machine at the execution time t2.

It is possible according to the current teaching to read out a unique identification of a sensor and thus conclusively identify the sensor. The identification of the sensor may be defined by the manufacturer of the sensor and/or by the manufacturer of the machine. The sensor identification is mostly deposited in a memory integrated into the sensor.

The inventive method allows conclusive determination of whether the first sensor and the second sensor are the same sensor and therefore the machine has not been altered with regard to the sensor between the delivery time t1 and the execution time t2.

Furthermore, the inventive method is based on the issuance of signatures for the processed values, i.e., the first sensor identification and the second sensor identification, according to digital signature schemes to protect the processed values against unrightful alteration. The method is thus integrous.

In a second embodiment, the inventive method is characterized by the following method steps:
at the delivery time t1, the computing unit compares the certificate time indication to the delivery time t1,
the computing unit issues a positive first verification indication, if the certificate time indication comprises the delivery time t1, or otherwise a negative first verification indication, if the certificate time indication does not comprise the delivery time t1,
the computing unit issues a first verification indication signature based on the first verification indication according to the digital signature scheme,
the computing unit saves the first verification indication signature in the internal database and in the external database,
at the execution time t2, the computing unit compares the certificate time indication to the execution time t2, the computing unit issues a positive second verification indication, if the certificate time indication comprises the execution time t2, or otherwise a negative second verification indication, if the certificate time indication does not comprise the execution time t2,
the computing unit issues a second verification indication signature based on the second verification indication according to the digital signature scheme,
the computing unit compares the first verification indication signature to the second verification indication signature,
the computing unit detects a safe operational state, if the first verification indication signature and the second verification indication signature match,
the computing unit detects an unsafe operational state, if the first verification indication signature and the second verification indication signature do not match.

The second embodiment of the inventive method focuses on evaluating an operational state depending on the existence of a time-specifically valid certificate. A first verification report including the first verification indication may be issued at the delivery time t1, and a second verification report having the second verification indication may be issued at the execution time t2.

The verification indication mentioned (the first verification indication or the second verification indication) may be a positive verification indication, if the certificate is time-specifically valid. The positive verification indication may, for example, say, “machine with valid certificate, 00:00”. The positive verification indication may be limited to the indication of the valid certificate. The positive verification indication may comprise a time indication, by which time indication the certificate time indication is exceeded at the execution time t2.

The verification indication mentioned may be a negative verification indication, if the certificate is not time-specifically valid and thus expired. The negative verification indication may, for example, say, “no valid machine certificate, 01:00”. The negative verification indication may also be limited to a time indication, by which time indication the validity of the certificate has expired.

The verification indication may comprise a text featuring a numerical value or the indication of a range.

The inventive method is further based on the issuance of signatures for the processed values, i.e., the first verification indication and the second verification indication, according to digital signature schemes to protect the processed values against unrightful alteration. The method is thus integrous.

In a third embodiment, the inventive method is characterized by the following method steps:
the computing unit issues a certificate time range comprising the delivery time t1 and the certificate time indication,
the computing unit issues a series of different standardized certificate time indications within the certificate time range, which certificate time indications have a uniform time format, wherein each time difference between the individual certificate time indications is equal to the smallest unit of the time format or higher,
the computing unit issues certificate time indication signatures based on the standardized certificate time indications according to the digital signature scheme,
the computing unit saves the certificate time indication signatures in the internal database and in the external database,
the computing unit issues a delivery time indication including the time format, which delivery time indication describes the delivery time t1,
the computing unit issues a delivery time indication signature based on the standardized delivery time indication,
the computing unit compares the delivery time indication signature to the certificate time indication signatures,
the computing unit detects a safe operational state, if the delivery time indication signature matches a certificate time indication signature,
the computing unit detects an unsafe operational state, if the delivery time indication signature does not match any certificate time indication signature.

A certificate may be valid, for example, until the certificate time indication 08.11.22. The delivery time t1 could be, for example, 06.11.22, at which delivery time t1 the machine would have a valid certificate. The computing unit issues a certificate time range from 06.11.22 (delivery time t1) to certificate time 08.11.22.

The computing unit further issues a series of mutually different certificate time indications, which certificate time indications have the format of the delivery time t1 and the certificate time. The certificate time indications differ by the smallest unit of the time format. The smallest unit of the time format may be dictated by the maximum accuracy of the time format.

In the example discussed herein, the time format is dd.mm.yy. The maximum accuracy of said time format, and its smallest unit is the indication of the date (dd). If the times and time indications mentioned above and below have different formats, the inventive method may comprise the method step of bringing said times and time indications into a uniform, standardizedformat.

In the example discussed herein, the series of different certificate time indications of the certificate range is 06.11.22, 07.11.22 and 08.11.22.

The computing unit issues a certificate time indication signature for each individual certificate time indication according to the digital signature scheme. Thus, a certificate time indication signature based on 06.11.22, another certificate time indication signature based on 07.11.22 and another certificate time indication signature based on 08.11.22 are issued.

The computing unit issues a delivery time indication signature of the delivery time t1, which delivery time t1 is present as a delivery time indication in the time format. The delivery time indication signature based on the delivery time indication 06.11.22 corresponds to the certificate time indication signature based on 06.11.22. Since the signatures mentioned are identical, the computing unit detects a safe operational state at the delivery time t1.

The fourth embodiment of the inventive method is characterized by the following method steps:
the computing unit issues a certificate time range comprising the delivery time t1 and the certificate time indication,
the computing unit issues a series of certificate time indications of the certificate time range, which certificate time indications have a uniform time format, wherein each time difference between the individual certificate time indications is equal to the smallest unit of the time format or higher,
the computing unit issues certificate time indication signatures based on the standardized certificate time indications according to the digital signature scheme,
the computing unit issues an execution time indication having the time format, which execution time indication describes the execution time t1,
the computing unit issues an execution time indication signature based on the execution time indication,
the computing unit compares the execution time indication signature to the certificate time indication signatures,
the computing unit detects a safe operational state, if the execution time indication signature matches a certificate time indication signature,
the computing unit detects an unsafe operational state, if the execution time indication signature does not match any certificate time indication signature.

Continuing discussion of the above example, the execution time t2 and the execution time indication which indicates the execution time t2 in the time format mentioned are 09.11.22. An execution time indication signature based on 09.11.22 does not match any of the certificate time indication signatures. The computing unit detects an unsafe operational state, since the certificate has expired by the execution time t2, 09.11.22.

In a fifth embodiment, the inventive method is characterized by the following method steps:
at the delivery time t1, the computing unit determines a first component identification of a first sensor as a first component,
the computing unit issues a first component identification signature based on the first component identification according to a digital signature scheme,
the computing unit saves the first component identification signature in the internal database and in the external database,
at the execution time t2, the computing unit requests a second component identification of a second sensor as a second component or the component control unit controls the second sensor to determine a measurement dataset,
in response to said request or in response to said control, the second sensor sends measurement dataset to the component control unit, which measurement dataset comprises a measurement value and the second sensor identification,
the computing unit saves the second sensor identification in the internal database,
the computing unit issues a second sensor identification signature based on the second sensor identification according to the digital signature scheme,
the computing unit compares the first sensor identification signature to the second sensor identification signature,
the computing unit detects a safe operational state, if the first sensor identification signature and the second sensor identification signature match,
the computing unit detects an unsafe operational state, if the first sensor identification signature and the second sensor identification signature do not match.

In prior art, a sensor can put out a dataset comprising a measurement value and the sensor identification. This particular feature is considered by the above embodiment of the inventive method.

In a sixth embodiment, the inventive method is characterized by the following method steps:
at a delivery time t1, the sensor computing unit controls the sensor to measure a first energy intake of an motor of the machine, which motor executes the movement predefined by the sensor computing unit,
in response to said control, the sensor determines the first energy intake of a drive of the machine,
the computing unit issues a positive first energy indication, if the first energy intake is within a predefined first energy intake range, or otherwise a negative first energy indication, if the first energy intake is not within a predefined first energy intake range,
the computing unit issues a first energy indication signature based on the first energy indication according to a digital signature scheme,
at an execution time t2, the sensor computing unit controls the sensor to measure a second energy intake of an motor of the machine, which motor executes the movement predefined by the sensor computing unit,
in response to said control, the sensor determines the second energy intake of a drive of the machine,
the computing unit issues a positive second energy indication, if the second energy intake is within a predefined second energy intake range, or otherwise a negative second energy indication, if the second energy intake is not within a predefined second energy intake range,
the computing unit issues a second energy indication signature based on the second energy indication according to a digital signature scheme,
the computing unit compares the first energy indication signature to the second energy indication signature,
the computing unit detects a safe operational state, if the first energy indication signature and the second energy indication signature match,
the computing unit detects an unsafe operational state, if the first energy indication signature and the second energy indication signature do not match.

The sensor control unit may control the sensor to determine the energy intake while executing a predefined movement, the predefined movement being, for example, the lifting of a tamping unit, the tamping unit being driven by the motor. The motor's driving power thus causes the tamping unit to be lifted. Instead of lifting the tamping unit, the operator may define other movements of other parts of the machine.

The predefined movement is executed at the delivery time t1 and at the execution time t2. The energy intake is determined for each of the predefined movements. Thus, the first energy intake is determined for the execution of the predefined movement at the delivery time t1. Further, the second energy intake is determined for the execution of the predefined movement at the execution time t2.

In a manner similar to that of the above embodiments of the inventive method, a first energy intake signature and a second energy intake signature are determined. The computing unit compares the energy intake signatures to detect a safe operational state or an unsafe operational state.

The energy intake may be subject to common variation. The determined energy intake is compared to an energy intake range, and a positive energy indication is issued, if the energy intake is within the energy intake range, while otherwise a negative energy indication is issued.

At the delivery time t1, a positive first energy indication is typically issued since the energy intake meets the standard.

At the execution time t2, a positive second energy indication is issued, if the determined second energy intake is within the second energy intake range.

The second energy intake range may equal the first energy intake range. Alternatively, the second energy intake range may equal the first energy intake range as varied by a factor to consider machine wear and/or a change in the motor's energy consumption. There is a change in the motor's energy consumption if a first motor energy consumption at the delivery time t1 is different from a second motor energy consumption at the execution time t2.

A positive second energy indication may be an indication that no part of the machine, such as a tamping unit, was altered between the delivery time t1 and the execution time t2.

A positive energy indication may be limited to the indication of the positive energy indication.

A negative energy indication may comprise an indication of the extent to which the determined energy intake differs from the energy intake range.

A seventh embodiment of the inventive method may comprise the following method steps:
at the delivery time t1, the computing unit issues a first user authorization signature based on a first positive user authorization according to the digital signature scheme,
the computing unit saves the first user authorization signature in the internal database and in the external database,
at the execution time t2, the sensor reads out the authorization time indication of the user,
the computing unit compares an authorization time indication of the user to the execution time t2, and the computing unit issues a second positive user authorization, if the authorization time indication comprises the execution time t2, or alternatively a second negative user authorization,
the computing unit issues a second user authorization signature based on the second user authorization according to the digital signature scheme and
the computing unit compares the second user authorization signature to the first user authorization signature of the internal database and/or the external database,
the computing unit detects a safe operational state, if the first user authorization signature and the second user authorization signature match, or otherwise an unsafe operational state, if the first user authorization signature and the second user authorization signature do not match.

The authorization time indication may be saved on a card, which card is read out by a card reader. The time when a person is allowed to operate the machine may be saved as an authorization time indication on the card.

The authorization time indication may indicate a time period, in which time period a person is authorized to perform an action.

It may be required for the user to insert the card into the card reader to read out the authorization time indication at predefined time intervals. This way, it can be prevented that the user registered via the card leaves the machine or that it is operated by a different user.

An authorization time indication which dictates reading of the card at time intervals does not comprise the execution time t2 if the card cannot be read at the dictated time. Also, such authorization time indication does not comprise the execution time t2 if the card cannot be read at the dictated time.

The positive user authorization may be limited to an indication of the positive user authorization. A negative user authorization may comprise a time value, by which time value the authorization time indication differs from the execution time t2.

The first positive user authorization may be issued by programming.

An eighth embodiment of the inventive method may comprise the following method steps:
a calibration value is applied to the sensor as a component,
the sensor determines a measurement value,
the computing unit issues a measurement value indication in a predefined numerical format from the measurement value,
the computing unit issues a measurement value signature based on the measurement value indication,
the computing unit issues a series of tolerance value indications from a predefined tolerance range, which tolerance value indications have the numerical format, wherein the difference between the individual tolerance value indications is equal to the smallest unit of the numerical format or higher,
the computing unit issues tolerance value signatures each based on the standardized tolerance value indications,
the computing unit saves the tolerance value signatures in the internal database and in the external database,
the computing unit compares the measurement value signature to the tolerance value signatures,
the computing unit detects a safe operational state, if the measurement value signature matches a tolerance signature,
the computing unit detects an unsafe operational state, if the measurement value signature does not match any tolerance value signature.

A first measurement value determined using a sensor may be 2.51, for example. The first measurement value may be determined at the delivery time t1. By rounding the first measurement value, this first measurement value is turned into a first measurement value indication, which first measurement value indication has a predefined numerical format. For example, the numerical format is predefined to comprise a decimal; the measurement value indication is therefore 2.5

The tolerance range, for example, is to be 2.4 to 2.5. It would thus comprise the tolerance values 2.4 and 2.5 as well as 2.5 within the predefined numerical format.

A first measurement value signatures based on the measurement value indication 2.5 corresponds to the tolerance value signature of 2.5. The computing unit detects a safe operational state at the delivery time t1.

The sensor may determine a second measurement value, 2.93, at an execution time t2. The second measurement value indication is 2.9. The second measurement value signature based on the second measurement value indication 2.9 corresponds neither to the tolerance value signature based on 2.4 nor to the tolerance value signature based on 2.5 nor to the tolerance value signature based on 2.6. The computing unit thus detects an unsafe operational state.

The inventive method may comprise at least two embodiments out of the first embodiment mentioned, the second embodiment mentioned, the third embodiment mentioned, the fourth embodiment mentioned, the fifth embodiment mentioned, the sixth embodiment mentioned, the seventh embodiment mentioned, and the eighth embodiment mentioned and may further be characterized by the following steps:
the computing unit detects an unsafe operational state, if
the first component identification signature and the second component identification signature or
the first verification indication signature and the second verification indication signature or
the delivery time signature does not match any certificate time indication signature while
the execution time signature does not match any certificate time indication signature,
the first sensor identification signature and the second sensor identification signature or
the first energy indication signature and the second energy indication signature or the measurement value signature does not match any tolerance value signature.

To summarize and in general, the inventive method may provide that at a delivery time t1, the first verification indication depending on validity of the certificate, a first identification of a part of the machine such as the first sensor and an energy intake for a predefined movement be ascertained. A first signature based on the first verification indication, the first sensor identification and the first energy intake is issued according to a digital signature scheme.

Furthermore, at an execution time t2, the second verification indication depending on the validity of the certificate, the second identification of a part of the machine such as the second sensor and a second energy intake for a predefined movement are ascertained. A second signature based on the second verification indication, the second sensor identification and the second energy intake is issued.

The second signature is issued exclusively based on values which are invariable given an unaltered state of the machine between the delivery time t1 and the execution time t2. Measurement values issued at the execution time t2, for example, are exempt.

Since the same signature schemes are employed for issuing the first signature and the second signature, the signatures are mutually comparable, so that an alteration of the machine or a negative validity of a certificate or an altered energy intake can be detected. If any alteration of the machine is detected based on the comparison of the signatures, this state of the machine is objectively regarded as an unsafe operational state. Otherwise, an operational state of the machine is objectively evaluated as safe, if the signatures are evaluated as identical.

At the delivery time t1, the machine is present in a first state created by a first person. The first person may be a machine manufacturer. In the inventive method, the first state is described by the first sensor identification and the first certificate validity.

At the execution time t2, the machine may be present in a second state caused by a second person. The second state may be different from the first state. The second person may be another machine builder. The second state becomes part of the inventive method by way of the second sensor identification and the second certificate validity.

An alteration of the machine detectable by means of this method may be a replacement of a sensor or an alteration of the validity of a certificate, in particular time-specific expiration of the certificate. The inventive method also allows detection of a replacement of movable parts by detecting the energy intake for executing the movement.

The inventive method may be characterized in that,
at the delivery time t1, the computing unit issues a first joint signature based on at least two indications from the first component identification and the first verification indication and the first sensor identification and the first energy indication and the first user authorization according to the digital signature scheme,
at the execution time t2, the computing unit issues a second joint signature based on at least two relevant indications from the second component identification and the second verification indication and the second sensor identification and the second energy indication and the second user authorization according to the digital signature scheme,
the computing unit compares the first joint signature and the second joint signature,
the computing unit detects a safe operational state, if the first joint signature and the second joint signature match,
the computing unit detects an unsafe operational state, if the first second joint signature and the second joint signature do not match.

The inventive method may be characterized in that,
at the delivery time t1, the computing unit issues
the first component identification signature exclusively based on the first component identification and
the first verification indication signature exclusively based on the first verification indication and
the first sensor identification signature exclusively based on the first sensor identification and
the first energy indication signature exclusively based on the first energy indication and
the first user authorization signature exclusively based on the first user authorization according to the digital signature scheme,
at the execution time t2, the computing unit
the second component identification signature exclusively based on the second component identification and
the second verification indication signature exclusively based on the second verification indication and
the second sensor identification signature exclusively based on the second sensor identification and
the energy indication signature exclusively based on the second energy indication and
the second user authorization signature exclusively based on the second user authorization according to the digital signature scheme,
the computing unit compares
the first component identification signature and the second component identification signature as well as the
first verification indication signature and the second verification indication signature as well as
the first sensor identification signature and the second sensor identification signature as well as
the first energy indication signature and the second energy indication signature as well as
the first user authorization signature and the second user authorization signature,
the computing unit detects a safe operational state, if
the first component identification signature and the second component identification signature as well as
the first verification indication signature and the second verification indication signature as well as
the first sensor identification signature and the second sensor identification signature as well as
the first energy indication signature and the second energy indication signature as well as
the first user authorization signature and the second user authorization signature match,
the computing unit detects an unsafe operational state, if
the first component identification signature and the second component identification signature or
the first verification indication signature and the second verification indication signature or
the first sensor identification signature and the second sensor identification signature or
the first energy indication signature and the second energy indication signature or
the first user authorization signature and the second user authorization signature do not match.

The inventive method may be characterized in that
the computing unit recognizes an operational state of the machine as a safe operational state and
the computing unit issues a record indicating the safe operational state.

The inventive method may be characterized in that
the computing unit recognizes an operation of a machine as an unsafe operational state and issues a record indicating the unsafe operational state.

The inventive method is preferably executed as a computer-implemented method. The record may be issued in the shape of a record file.

A safe operational state of the machine may require that the machine be operated by an authorized person, for example.

The inventive method may be characterized in that
the component control unit sends a command file to the sensor for controlling the sensor as a component,
which command file comprises a special command, and
the component control unit controls the sensor to determine the measurement value at a measurement location and/or a measurement time according to the command file.

The inventive method may comprise that
a calibration value is applied to the sensor,
the computing unit compares the measurement value measured using the sensor to a calibration value,
the computing unit determines a measurement deviation of the sensor, by which measurement deviation the measurement value differs from the calibration value,
the computing unit evaluates the operational state as unsafe when the measurement deviation exceeds a predefined tolerance.

The comparison described herein between the measurement value and a calibration value may be executed at the delivery time t1 and/or at the execution time t2. In doing so, the operator may adhere to provisions of standards etc.

The comparison mentioned may be such that the sensor including a calibration value applied issues a measurement value, which measurement value is compared to the calibration value. This is to verify whether the sensor is correctly issuing a measurement value.

The inventive method may be characterized in that,
at the delivery time t1, a calibration value is applied to the sensor,
the computing unit compares the measurement value measured using the sensor to a calibration value,
the computing unit determines a first measurement deviation of the sensor, by which first measurement deviation the measurement value differs from the calibration value,
at the execution time t2, a calibration value is applied to the sensor,
the computing unit den compares the measurement value measured using the sensor to a calibration value,
the computing unit determines a second measurement deviation of the sensor, by which second measurement deviation the measurement value differs from the calibration value,
at a delivery time t1, the computing unit issues a first positive sensor measurement status, if a first measurement deviation is within tolerance, or a first negative sensor measurement status, if a first measurement deviation is outside tolerance,
the computing unit issues a first sensor measurement status signature based on the first sensor measurement status according to the digital signature scheme,
the computing unit saves the first sensor measurement status signature in the internal database and in the external database,
at an execution time t2, the computing unit issues a second positive sensor measurement status, if a second measurement deviation is within tolerance, or a second negative sensor measurement status, if a second measurement deviation is outside tolerance,
the computing unit issues a second sensor measurement status signature based on the second sensor measurement status according to the digital signature scheme,
the computing unit evaluates an operational state as safe, if the first sensor measurement status signature and the second sensor measurement status signature match, or as unsafe, if the first sensor measurement status signature and the second sensor measurement status signature do not match.

The positive sensor measurement status may be limited to an indication of the positive sensor measurement status.

The negative sensor measurement status may comprise the determined measurement deviation in the shape of numerical value or a tolerance exceedance. The tolerance exceedance is the measurement deviation minus the tolerance.

The negative sensor measurement status may comprise an indication of the negative sensor measurement status.

The inventive method may be characterized in that
the computing unit sends a command to determine the measurement value at the delivery time t1 and/or at the execution time t2 to the sensor control unit.

A sensor of the machine is subjected to various environmental influences which may reduce the accuracy of the sensor. It may thus be required to verify the accuracy of the sensor at the execution time t1, with an accuracy of the sensor at the delivery time t2 being available as a reference state.

The calibration value mentioned may also be a range indication. The measurement status may be a binary value.

It is also feasible that the computing unit compares a measurement value and a calibration value at the delivery time t1 and at the execution time t2. The computing unit may also compute a digital reference signature and a digital signature of a deviation between measurement value and calibration value or the like. Such a variation of the inventive method would be feasible but less advantageous, since already a minor, irrelevant change in deviation would result in a negative sensor measurement status, unless compensated by laborious mathematical measures.

The inventive method may be characterized in that
the computing unit sends to the sensor control unit a command to determine a measurement value or
measurement data at a time previous to the delivery time t1 or the execution time t2 and
another command to determine another measurement value or other measurement data at a time subsequent to the delivery time t1 or the execution time t2.

In particular, the accuracy of a sensor may be verified immediately prior to and immediately after the execution of maintenance works. The verification mentioned herein and above of the accuracy of a sensor may also comprise verification of the sensor's functionality.

The inventive method may be characterized in that
the sensor determines the measurement value,
the sensor computation unit issues a measurement value signature based on the measurement value put out by the sensor according to the digital signature scheme,
the computing unit issues a measurement record comprising the measurement value,
the computing unit issues a record file signature based on the measurement value comprised in the record file according to the digital signature scheme,
the computing unit issues the record file comprising a positive report status, if the measurement value signature and the record file signature match, or otherwise a negative report status, if the measurement value signature and the record file signature do not match,
the computing unit puts out the report status in the record file.

The measurement values are thereby prevented from being recorded exclusively in the documentation file and also from being easily manipulated. For this reason, a digital signature of the measurement value is issued immediately after the sensor has sent the measurement value to the sensor computation unit and before the user has knowledge of the existence of the measurement value. The signature is thus issued at a time when no manipulation of the measurement value is feasible.

The other digital signature is issued when the measurement value is processed for indication. The second signature is thus issued at a time when the user has the opportunity to alter the measurement value by disregarding provisions. Such alteration can be detected by comparing the digital signatures.

### BRIEF DESCRIPTION OF THE DRAWINGS

The invention is additionally explained based on the following embodiments shown in the figures:

FIG. 1 shows the method steps of the inventive method at the delivery time;

FIG. 2 shows the method steps of the inventive method at an execution time.

### DETAILED DESCRIPTION

The embodiments in the figures merely show possible embodiments, however, it should be noted that the invention is not limited to these specifically shown variant embodiments thereof, but that combinations among the individual variant embodiments as well as combinations of one embodiment with the above general description are possible. Such other possible combinations do not need to be expressly mentioned, since these other possible combinations lie within the knowledge of a person of skill in the relevant art based on the technical teaching of the present invention.

The scope of protection is defined by the claims. However, the description and the drawings are to be used in interpreting the claims. Individual features or combinations of features from the various embodiments shown and described may represent distinct inventive solutions in themselves. The object underlying such distinct inventive solutions may be taken from the description.

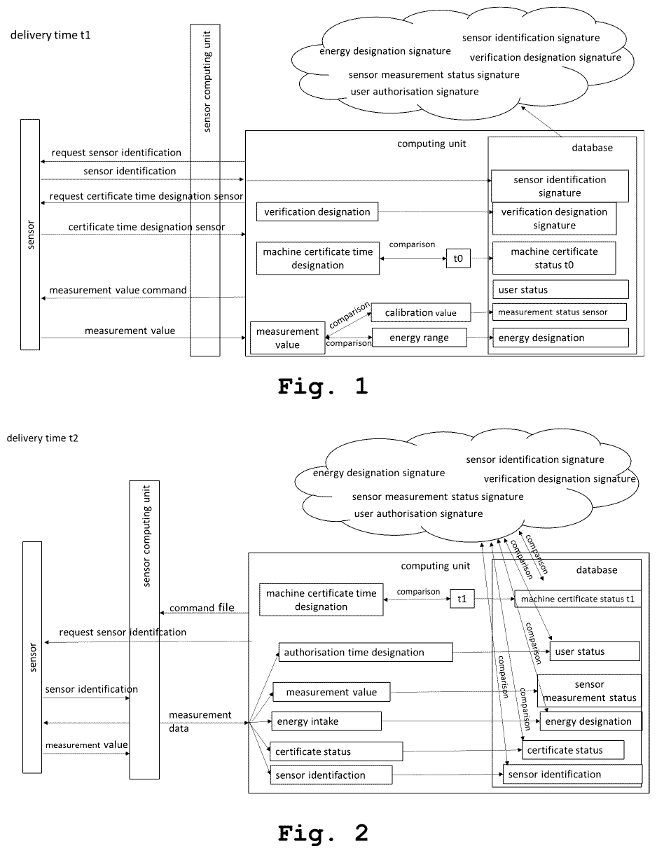

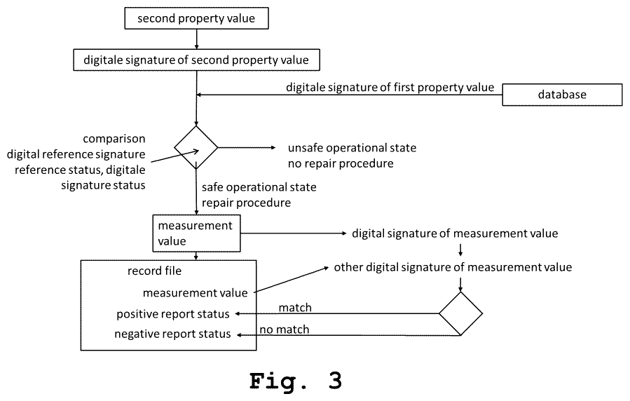

FIGS. 1 and 2 illustrate the inventive method comprising the above first embodiment and the above second embodiment.

Generally, FIG. 1 illustrates the method steps of the delivery time t1. Generally, FIG. 2 shows the method steps of the execution time t1. The inventive method may comprise the method steps illustrated in FIGS. 1 and 2.

The inventive method disclosed herein undertakes the object of detecting whether a machine for repairing a track—also referred to herein as a repair machine—, when repair works are executed by a user at an execution time t2, exhibits the same state in which the machine has been delivered by the machine manufacturer at the delivery time t1.

Machines used in the railway industry are often altered by third parties without knowledge or consent of the machine manufacturer. Operation of an altered machine is generally to be regarded as an unsafe operational state; operation of an unaltered machine is considered a safe operational state with regard to operational safety and the result of works employing the machine.

The method disclosed herein is executed as a computer-implemented method.

The machine comprises a computing unit, at least one sensor to record at least one measurement value of a track and a sensor control unit.

The computing unit may be regarded as a central control unit for controlling the machine. The computing unit comprises a timer.

The timer mentioned may be the only timer of the machine and components of the machine such as a sensor of the machine may request a time value from said only timer if control of the components requires a time value. It is thereby achieved that control of the components is based on a single time value dictated by the only timer. It is thereby achieved in particular that a time is described by a single time value rather than a plurality of time values synchronising with respect to one another.

The sensor control unit controls the sensor for recording the at least one measurement value. Control of the sensor may be such that the sensor control unit indicates a measurement time and/or location to determine the measurement value independently of the frequency or any other property of the sensor, as is known in prior art.

The machine further comprises an internal database. In the internal database, a certificate of the machine or part of the machine such as a sensor is saved. The certificate comprises a certificate time indication, by which the time at which a certificate is valid is clearly defined.

There are data connections between the units mentioned, the internal database and further an external database. The data connections and the databases may have different reading and writing rights.

The inventive method is based on a definition of three possible states of the machine.

One state of the machine is the delivery state of the machine at a delivery time t1 as created by the machine builder and handed over to a client as the user.

The other states are operational states in which the machine is in the responsibility of the client as user.

One other state of the machine is a safe operational state of the machine in operation at an execution time t2. The safe operational state of the machine essentially equals the delivery state, the certificates being valid.

As opposed to the safe operational state, an unsafe operational state may also prevail. An unsafe operational state prevails when the machine or parts of the machine are altered in comparison to the delivery state and/or a certificate has expired.

The inventive method undertakes the object to detect whether the machine is in a safe or an unsafe operational state at an execution time t2 subsequent to the delivery time t1. To execute the inventive method, the following method steps are required. The order of the method steps is merely defined by stating the respective times such as the execution time t1, the execution time t2, but otherwise free.

FIG. 1 illustrates the method steps of the inventive method at the delivery time t1.

At the delivery time t1, the computing unit determines a first sensor identification of the first sensor present at the delivery time t1. By applying methods from prior art, a sensor identification of a sensor in general, here the first sensor identification of the sensor, may be requested. The first sensor transmits its first sensor identification in response to said request.

The first sensor identification may be a multi-digit code, by which code the manufacturer of the sensor, or the manufacturer of the machine, marks the respective sensor as unique. Such codes for sensor identification are known according to the current teaching.

The computing unit may save the first sensor identification in an internal database.

Furthermore, the computing unit issues, at the execution time t1, a first sensor identification signature based on the first sensor identification according to a digital signature scheme. The computing unit saves the first signature in the internal database and in the external database.

The external database may be a cloud database, for example.

At the delivery time t1, the computing unit compares the certificate time indication of a certificate deposited in the internal database at the delivery time t1. The computing unit issues a positive first verification indication, if the certificate time indication comprises the delivery time t1, or alternatively a negative first verification indication.

A verification report issued according to common practice may comprise a such verification indication. A positive verification indication may be limited to the indication of the positive verification indication such as “certificate OK”, for example. A negative verification indication may comprise the indication of the time value by which the certificate time indication exceeds the execution time t1.

Since only a machine having a valid signature is typically delivered, the first verification indication is typically positive.

It is also feasible for the first positive verification indication to be issued by programming.

The computing unit issues a first verification indication signature based on the first verification indication according to the digital signature scheme. The computing unit saves the verification indication signature in the internal database and in the external database.

Furthermore, at the delivery time t1, a first energy intake of a motor is determined via a sensor. The sensor mentioned may be the first sensor. The first energy intake may require the motor to initiate a predefined movement of a mechanical part at the delivery time t1.

The first energy intake is compared to a first energy intake range. Since the machine may generally be assumed to meet the given requirements at the delivery time t1, a positive first energy indication is issued.

The above description comprises indications regarding the content of a positive energy indication and a negative energy indication. The positive energy indication may comprise, for example, the indication “energy intake OK” or a numerical value such as “100”, for example.

The computing unit in turn issues a first energy indication signature based on the first energy indication. The energy indication signature is saved in the internal database and in the external database.

To summarize, the inventive method enables the machine builder to document the state of the delivered machine at the delivery time t1 based on the first sensor identification, the first certificate time indication and the first energy intake to execute a predefined movement.

Preferably, the machine builder has the exclusive writing right and reading rights on the internal database and the external database to document the state of the machine based on the first sensor identification and on certificate validity in the respective database.

FIG. 2 illustrates the method steps of the inventive method at the execution time t2, which execution time t2 is subsequent to the delivery time t1. The method steps at the execution time t2 relate essentially the operation of the machine on the railway line.

At the execution time t2, the second sensor identification of the second sensor is ascertained.

The second sensor identification of the second sensor at the execution time t2 may be such that the computing unit requests the second sensor identification of the second sensor from the same second sensor or in an equivalent manner from a data storage. Alternatively or additionally, the sensor control unit may control the second sensor to determine a measurement value.

In response to said request or in response to said control of the computing unit, the second sensor sends a measurement dataset to the sensor control unit.

The measurement dataset comprises the measurement value and the second sensor identification. In the request of the second sensor identification mentioned above, the measurement value is typically zero. In the control mentioned above, the measurement value is the value determined by the second sensor.

The computing unit may save the second sensor identification in the internal database. The second sensor identification may be saved as part of the measurement dataset or separately from the same.

The computing unit issues a second sensor identification signature based on the second sensor identification according to the digital signature scheme, which digital signature scheme was also applied in issuing the first sensor identification signature.

The sensor identification signature is not issued based on the measurement value determined according to the digital signature scheme.

At the execution time t2, the computing unit compares the certificate time indication to the execution time t2. The computing unit issues a positive second verification indication, if the certificate time indication comprises the execution time t2, or alternatively a negative second certificate validity.

The second verification indication may in turn be part of a verification report. The second verification indication is issued according to the same principle as the first verification indication.

The positive second verification indication may comprise only the positive second verification indication. In this respect, examples of the positive first verification indication are given above, which examples are to be applied to the second verification indication.

The negative second verification indication may comprise a time value, by which the execution time t2 exceeds the certificate time. Additionally, the negative second verification indication may comprise an indication “certificate not OK”.

A certificate may be a certificate valid for a predefined time span starting at the delivery time t1. In the context of the disclosure of the inventive method, the delivery time t1 may be the time at which the machine is handed over to the user by the machine manufacturer ex-factory or on the railway line following a review to execute maintenance works.

The certificate time indication is a time within the time span mentioned, in which time span the certificate is valid, and thus defines the time at which the machine has a valid certificate. By comparing the certificate time indication to the delivery time t1 or to the execution time t2, it is detected whether the machine has a time-specifically valid certificate at the delivery time t1, or at the execution time t2.

The second verification indication issued at the execution time t2 may be saved in an internal database by the computing unit.

Furthermore, the second verification indication signature is issued based on the second verification indication according to the digital signature scheme which is also applied in issuing the first verification indication signature.

It should be noted in particular that the digital signature scheme for issuing the sensor identification signatures and the digital signature scheme for issuing the verification indication signatures do not have to be the same signature scheme.

The second energy intake of the motor to execute a predefined movement of a part of the machine is determined at the execution time. A second energy intake different from the first energy intake is an indication for said machine part having been replaced or altered.

The second energy intake is compared to a second energy intake range. The second energy intake range is a range indication of the first energy intake range changed by a factor. It is thereby prevented that a regular alteration of the machine and associated change in energy requirement results in the false assumption that the machine part mentioned has been replaced between the delivery time t1 and the execution time.

A positive or negative second energy indication is in turn issued as sufficiently disclosed in the description. The negative second energy indication may comprise a variable value depending on the energy intake determined. The negative second energy indication may say, for example: “energy intake not OK, exceeded by 10%”.

A second energy indication signature of the second energy indication is issued. The second energy indication signature is saved in the internal database and in the external database.

The inventive method may comprise the method step of a record file being issued. The record file may constitute an output of measurement data over a time period comprising the execution time t2. The record file may comprise the output of multiple measurement data points issued at successive execution times.

Since the inventive method is a computer-implemented method, the record file is present as a file. Additionally, the content of the record file may also be printed and then be present on paper.

The inventive method allows determining a safe operational state of the machine at the execution time t2.

The first sensor identification signature, the first verification indication signature and the first energy indication signature are present as first signatures. The first signatures describe the state of the machine at the delivery time t1.

Furthermore, the second sensor identification signature, the second verification indication signature and the second energy indication signature are present as second signatures. The second signatures describe the state of the machine at the execution time t2.

Evaluation of the operational state as a safe operational state or as an unsafe operational state is based on a comparison between the first signatures and the second signatures.

Issuance of the first signatures and the second signatures is designed such that the first signatures and the second signatures are the same if the machine at the delivery time t1 equals the machine at the execution time t2. The first signatures and the second signatures are issued exclusively based on values which are equal in a machine that is the same at the delivery time t1 as at the execution time t2.

To do so, when the data connection is active between the computing unit and the external database, the computing unit compares the first signatures issued at the delivery time t1 that are saved in the external database to the second digital signature issued at the execution time t2.

No data connection may exist between the computing unit and the external database. This may be the case, for example, when the machine is in a tunnel and the external database is a cloud storage.

If no data connection is active between the computing unit and the external database, the computing unit compares the first signatures issued at the delivery time t1 that are saved in the internal database to the signature issued at the execution time t2.

The inventive method may also comprise a two-stage comparison of the digital signatures. The second signatures are compared to the first signatures saved in the internal database in a first comparison step and to the first signatures saved in the external database in a second comparison step. The second comparison step may be executed independently of or depending on the result of the first comparison step.

A record file issued to conclude the inventive method may comprise an indication of whether the operational state of the machine is to be regarded as safe or unsafe. The inventive method has the advantage over methods of prior art that such evaluation is exclusively based on objective criteria.

By definition, a safe operational state prevails if at the execution time t2, the second state of the machine equals the first state of the machine, and the certificates are time-specifically valid. A such safe operational state is clearly visible using the inventive method if the first signatures equal the second signatures. This comparison statement is achieved by the signatures being issued based on values which do not change between the delivery time t1 and the execution time t2 in the case of a safe operational state. This includes no sensors of the machine having been changed and a time-specifically valid certificate existing.

A safe operational state prevails if the first sensor identification signature and the second sensor identification signature as well as the first verification indication signature and the second verification indication signature as well as the first energy indication signature and the second energy indication signature are identical. The computing unit detects this by comparing the said signatures.

Alternatively, an unsafe operational state may be recognized. An unsafe operational state prevails if a sensor of the machine has been altered, or the certificate is time-specifically invalid. An unsafe operational state prevails if the first sensor identification signature and the second sensor identification signature or the first verification indication signature and the second verification indication signature or the first energy indication signature and the second energy indication signature are different. The computing unit detects this by comparing the said signatures.

The inventive method may be extended by the determination of a user authorization.

The measurement value determined using the sensor may be a measurement value describing a user. The machine may comprise a sensor for reading out user data. The sensor may comprise, for example, a card reader to read user data.

The inventive method may comprise that at the delivery time t1, the computing unit issues a user authorization signature based on a first positive user authorization according to the digital signature scheme. The computing unit saves the first user authorization signature in the internal database and in the external database.

The first positive user authorization may be programmed.

At the execution time t2, the computing unit compares an authorization time indication of the user to the execution time t2. The computing unit issues a second positive user authorization, if the authorization time indication comprises the execution time t1, or otherwise a second negative user authorization, if the authorization time indication does not comprise the execution time t1.

The authorization time indication mentioned may be saved on a card, which card is read out using a card reader comprising the sensor.

The computing unit issues a second user authorization signature based on the second user authorization. The same encryption method as in issuing the first user authorization signature is applied.

To evaluate the operational state, the computing unit compares the first user authorization signature to the second user authorization signature of the internal database and/or the external database. A safe operational state prevails if the first user authorization signature equals the second user authorization signature, and the above conditions of a safe operational state apply as well. Otherwise, the operational state is evaluated as unsafe, if a first signature and a second signature are different.

The inventive method may also comprise the operation being assessed with regard to a valid sensor measurement status of the sensor.

For example, it is proposed by the applicable standards to apply a calibrated value to the sensor, to determine the measurement value and to compare the measurement value to a calibration value. The sensor sends the measurement value to the computing unit. The computing unit compares the measurement value to the calibration value and issues a positive sensor measurement status, if the measurement value equals the calibration value, or alternatively a negative sensor measurement status.

The positive sensor measurement status may be limited to the indication of the positive sensor measurement status. The negative sensor measurement status may comprise a deviation indication, by which the measurement value differs from the calibration value. The deviation indication may be a numerical value or the indication of a range.

This process of determining the sensor measurement status may be determined at the delivery time t1. Since only a machine that meets the standards is allowed to be delivered, a first positive sensor measurement status is issued at the delivery time t1. The computing unit issues a first sensor measurement status signature based on the measurement status according to a digital signature scheme. The signature of the first sensor measurement status is saved in the internal database and/or in the external database.

Moreover, a positive sensor measurement status may also be issued at the delivery time t1 by programming. This has the drawback, however, of the sensor's accuracy not being verified.

In analogy to the determination of the first sensor measurement status, the second sensor measurement status at the execution time t2 may also be determined. A sensor measurement status at a time prior to the execution time t2 and/or at a time subsequent to the execution time t2 may also be determined.

The computing unit issues a second sensor measurement status signature based on the second sensor measurement status according to the digital signature scheme.

To evaluate the operational state, the computing unit compares the first measurement status signature to the second sensor measurement status signature of the internal database and/or the external database. A safe operational state prevails if the first sensor measurement status signature equals the second sensor measurement status signature, and the above conditions of a safe operational state are met as well. Otherwise, the operational state is evaluated as unsafe, if a first signature and a second signature are different.

FIG. 3 illustrates in particular a part of the inventive method which is processed after or during the execution time t2 in a way different from the depiction in FIG. 2. Evaluation of the operational state as safe or unsafe is generally explained based on a property of the machine.

The machine property observed in the following is most generally described by a value which is referred to in the following as a property value. With reference to the above description, the property value may be an identification or a time indication.

At a delivery time t1, the computing unit determines a first property value of a first part of the machine. The computing unit may save the first property value in the internal database. The first property value of the internal database may as such be read by other units of the machine for further processing such as the execution of a comparison to another value. This is not the subject of observation in FIG. 3.

The computing unit issues a first signature based on the first property value of the first unit if the machine according to a digital signature scheme. The first signature of the first property value is issued to be able to compare a second property value determined at a subsequent execution time t2 to the first property value by a safe, integrous method.

The computing unit saves the first signature of the first property value in an external database such as a cloud, for example. The external database is arranged outside of the machine. It is thereby achieved that documentation of the first property value is in the discretionary power of the machine builder. The first signature can only be retrieved from the external database if a data connection between the machine and the external database exists.

The computing unit saves the first signature of the first property value in an internal database. This is to enable comparison of the property values if there is no data connection between the machine and the external database.

The computing unit determines, at an execution time t2, the second property value of a second part of the machine.

The computing unit determines a second signature based on the second property value according to the digital encryption scheme, which is also applied to issue the first signature.

When a data connection between the computing unit and the external database is active, the computing unit retrieves the first signature of the first property value from the external database. Alternatively or additionally, the computing unit may retrieve the first signature of the first property value from the internal database. In FIG. 3, the external database and the internal database are shown in a simplified manner as one database. The depiction in FIG. 3 does not differentiate between the said databases.

The computing unit compares the first signature to the second digital signature. If the digital signatures are identical, the operational state is to be evaluated as safe. The operational state is to be evaluated as unsafe if the first signature and the second signature do not match.

In addition to evaluating the operation as unsafe, the repair procedure may also be stopped.

In the case of a safe operational state, a measurement value is first determined using at least one sensor. The inventive method may comprise a definition of conditions under which a measurement value may be determined using a sensor in the case of an unsafe operational state.

The inventive method may be characterized in that the sensor computation unit issues a signature of those measurement values according to a digital signature scheme which measurement value are put out by the sensor and/or received by the sensor computation unit. A first signature of the measurement values is thus issued before the measurement values can be altered by a person in a manner not specified in more detail herein.

The computing unit issues another signature of those measurement values according to a digital signature scheme which are comprised in a record file.

A positive report status is registered in the record file if the digital signature of the measurement values and the other digital signature of the measurement values match. A negative report status is registered in the record file if the digital signature of the measurement values and the other digital signature of the measurement values do not match.

It is thereby prevented that the measurement values stated in the record file differ from the measurement values (actually) determined by the sensor due to some unauthorized manipulation. The issuance of the report status may be done in parallel with the issuance of the record file.

1-19. (canceled)

20. A method of detecting a safe operational state of a machine for maintaining a railway line at an execution time t2;
wherein the machine comprises a computing unit including a timer, at least one electronic component, a component control unit, and an internal database;
wherein the component control unit controls the component;
wherein the internal database saves a certificate of the machine including a certificate time indication;
wherein data connections exist between the units mentioned and at least one of the internal database and an external database;
wherein the machine is configured to be in one of a delivery state at a delivery time t1, in a safe operational state at the execution time t2, and an unsafe operational state at the execution time t2;
wherein the timer outputs the delivery time t1 and the execution time t2;
wherein the delivery time t1 is prior to the execution time t2;
the method comprising:
determining by the computing unit, at the delivery time t1, a first component identification of a first component;
issuing by the computing unit a first component identification signature based on the first component identification according to a digital signature scheme;
saving by the computing unit the first component identification signature in the internal database and in the external database;
requesting by the computing unit, at the execution time t2, a second component identification of a second component;
sending by the second component, in response to the requesting, a dataset to the component control unit, the dataset comprising the second component identification;
saving by the computing unit the second component identification in the internal database;
issuing by the computing unit a second component identification signature based on the second component identification according to the digital signature scheme;
comparing by the computing unit the first component identification signature to the second component identification signature;
detecting by the computing unit the safe operational state if the first component identification signature and the second component identification signature match; and
detecting by the computing unit the unsafe operational state if the first component identification signature and the second component identification signature do not match.

21. A method of detecting a safe operational state of a machine for maintaining a railway line at an execution time t2;
wherein the machine comprises a computing unit including a timer, at least one electronic component, a component control unit, and an internal database;
wherein the component control unit controls the component;
wherein the internal database saves a certificate of the machine including a certificate time indication;
wherein data connections exist between the units mentioned and at least one of the internal database and an external database;
wherein the machine is configured to be in one of a delivery state at a delivery time t1, in a safe operational state at the execution time t2, and an unsafe operational state at the execution time t2;
wherein the timer outputs the delivery time t1 and the execution time t2;
wherein the delivery time t1 is prior to the execution time t2;
the method comprising:
issuing by the computing unit a certificate time range comprising the delivery time t1 and the certificate time indication;
issuing by the computing unit a series of certificate time indications within the certificate time range, the certificate time indications of the series having a uniform time format, a time difference between successive certificate time indications being equal to one of a smallest unit of the time format and longer;
issuing by the computing unit certificate time indication signatures based on the certificate time indications according to the digital signature scheme;
saving by the computing unit the certificate time indication signatures in the internal database and in the external database;
issuing by the computing unit a delivery time indication including the time format, the delivery time indication describing the delivery time t1;
issuing by the computing unit a delivery time indication signature based on the standardised delivery time indication;
comparing by the computing unit the delivery time indication signature or the execution time indication signature to the certificate time indication signatures;
detecting by the computing unit the safe operational state if the delivery time indication signature matches at least one of the certificate time indication signatures; and
detecting by the computing unit the unsafe operational state if the delivery time indication signature does not match any certificate time indication signature.

22. The method of detecting the safe operational state of the machine for maintaining the railway line at the execution time t2 according to claim 20, wherein:
the first component is a first sensor and the second component is a second sensor;
the first component identification signature comprises a first measurement value; and
the second component identification signature comprises a second measurement value.

23. A method of detecting a safe operational state of a machine for maintaining a railway line at an execution time t2;
wherein the machine comprises a computing unit including a timer, at least one electronic component, a component control unit, and an internal database;
wherein the component control unit controls the component;
wherein the internal database saves a certificate of the machine including a certificate time indication;
wherein data connections exist between the units mentioned and at least one of the internal database and an external database;
wherein the machine is configured to be in one of a delivery state at a delivery time t1, in a safe operational state at the execution time t2, and an unsafe operational state at the execution time t2;
wherein the timer outputs the delivery time t1 and the execution time t2;
wherein the delivery time t1 is prior to the execution time t2;
the method comprising:
issuing by the component control, at the delivery time t1, a first user authorization signature based on a first positive user authorization according to the digital signature scheme;
saving by the computing unit the first user authorization signature in the internal database and in the external database;
reading out by the sensor, at the execution time t2, the authorization time indication for the user;
comparing by the computing unit an authorization time indication for the user to the execution time t2;
issuing by the computing unit a second user authorization, the second user authorization being positive if the authorization time indication comprises the execution time t2 and the second user authorization otherwise being negative;
issuing by the computing unit a second user authorization signature based on the second user authorization according to the digital signature scheme;
comparing by the computing unit the second user authorization signature to the first user authorization signature of at least one of the internal database and the external database;
determining by the computing unit the safe operational state if the first user authorization signature and the second user authorization signature match; and
determining by the computing unit the unsafe operational state if the first user authorization signature and the second user authorization signature do not match.

24. The method of detecting the safe operational state of the machine for maintaining the railway line at the execution time t2 according to claim 22, further comprising:
applying a calibration value to the sensor as a component;
determining by the sensor a measurement value;
issuing by the computing unit a measurement value indication in a predefined numerical format from the measurement value;
issuing by the computing unit a measurement value signature based on the measurement value indication;
issuing by the computing unit a series of tolerance value indications from a predefined tolerance range, the tolerance value indications having the numerical format, the difference between the individual tolerance value indications being equal to a smallest unit of the numerical format or higher,
issuing by the computing unit tolerance value signatures each based on the standardised tolerance value indications;
saving by the computing unit the tolerance value signatures in the internal database and in the external database;
comparing by the computing unit the measurement value signature to the tolerance value signatures;
detecting by the computing unit the safe operational state if the measurement value signature matches a tolerance signature; and
detecting by the computing unit the unsafe operational state if the measurement value signature does not match any tolerance value signature.

25. The method according to claim 20, wherein the computing unit recognizes an operational state of the machine as the safe operational state and the computing unit outputs a record indicating the safe operational state.

26. The method according to claim 20, wherein the computing unit recognizes an operational state of the machine as the unsafe operational state and the computing unit outputs a record indicating the unsafe operational state.

27. The method according to claim 21, wherein the computing unit recognizes an operational state of the machine as the safe operational state and the computing unit outputs a record indicating the safe operational state.

28. The method according to claim 21, wherein the computing unit recognizes an operational state of the machine as the unsafe operational state and the computing unit outputs a record indicating the unsafe operational state.

29. The method according to claim 23, wherein the computing unit recognizes an operational state of the machine as the safe operational state and the computing unit outputs a record indicating the safe operational state.

30. The method according to claim 23, wherein the computing unit recognizes an operational state of the machine as the unsafe operational state and the computing unit outputs a record indicating the unsafe operational state.

31. The method according to claim 24, wherein:
the component control unit sends a command file to the sensor as a component to control the sensor as a component;
the command file comprises a special command; and
the component control unit controls the sensor to determine the measurement value at at least one of a measurement location and a measurement time according to the command file.

32. The method according to claim 24, wherein:
a calibration value is applied to the sensor;
the computing unit compares the measurement value measured using the sensor to a calibration value;
the computing unit determines a measurement deviation of the sensor, by which measurement deviation the measurement value differs from the calibration value; and
the computing unit evaluates the operational state as unsafe when the measurement deviation exceeds a predefined tolerance.

33. The method according to claim 24, wherein:
at the delivery time t1, a calibration value is applied to the sensor;
the computing unit compares the measurement value measured using the sensor to a calibration value;
the computing unit determines a first measurement deviation of the sensor, by which first measurement deviation the measurement value differs from the calibration value;
at the execution time t2, a calibration value is applied to the sensor;
the computing unit compares the measurement value measured using the sensor to a calibration value;
the computing unit determines a second measurement deviation of the sensor, by which second measurement deviation the measurement value differs from the calibration value;
at a delivery time t1, the computing unit issues a first positive sensor measurement status, if a first measurement deviation is within the tolerance, or a first negative sensor measurement status, if a first measurement deviation is outside the tolerance;
the computing unit issues a first sensor measurement status signature based on the first sensor measurement status according to the digital signature scheme;
the computing unit saves the first sensor measurement status signature in the internal database and in the external database;
at an execution time t2, the computing unit issues a second positive sensor measurement status, if a second measurement deviation is within the tolerance, or a second negative sensor measurement status, if a second measurement deviation is outside the tolerance;
the computing unit issues a second sensor measurement status signature based on the second sensor measurement status according to the digital signature scheme; and
the computing unit evaluates an operational state as safe, if the first sensor measurement status signature and the second sensor measurement status signature match, or as unsafe, if the first sensor measurement status signature and the second sensor measurement status signature do not match.

34. The method according to claim 24, wherein the computing unit sends the sensor command to determine the measurement value to the component control unit at at least one of the delivery time t1 and at the execution time t2.

35. The method according to claim 24, wherein the computing unit sends to the component control unit the sensor command to determine a measurement value or measurement data at a time prior to the delivery time t1 or the execution time t2 and another command to determine another measurement value or more measurement data at a time subsequent to the delivery time t1 or the execution time t2.

36. The method according to claim 24, wherein:
the sensor determines the measurement value;
the component control unit issues a measurement value signature based on the measurement value put out by the sensor according to the digital signature scheme;
the computing unit issues a measurement record comprising the measurement value;
the computing unit issues a record file signature based on the measurement value comprised in the record file according to the digital signature scheme;
the computing unit issues the record file comprising a positive report status, if the measurement value signature and the record file signature match, or otherwise a negative report status, if the measurement value signature and the record file signature do not match; and
the computing unit puts out the report status in the record file.
